(19) United States
(12) Patent Application Publication
(10) Pub. No.: US 2026/0143483 A1
(43) Pub. Date: May 21, 2026

(54) SEMI-PERSISTENT SCHEDULING CONFIGURATIONS INCLUDING TIMER CONFIGURATIONS

(71) Applicant: Lenovo (Singapore) Pte. Limited, Singapore (SG)

(72) Inventors: Joachim Löhr, Wiesbaden (DE); Hyung-Nam Choi, Ottobrunn (DE); Prateek Basu Mallick, Dreieich (DE); Razvan-Andrei Stoica, Essen (DE)

(73) Assignee: Lenovo (Singapore) Pte. Limited, Singapore (SG)

(21) Appl. No.: 19/109,927

(22) PCT Filed: Aug. 30, 2023
(86) PCT No.: PCT/IB2023/058585

§ 371 Date: Mar. 7, 2025

Related U.S. Application Data
(60) Provisional application No. 63/407,015, filed on Sep. 15, 2022.

(51) Int. Cl. H04W 72/11; H04W 72/23; H04W 76/28

(52) U.S. Cl. CPC H04W 72/11; H04W 72/23; H04W 76/28

(57) ABSTRACT

Various aspects of the present disclosure relate to providing efficient support of multiple traffic flows (e.g., data traffic flows) for various applications, such as extended reality applications. Different ones of these multiple traffic flows can have different characteristics, such as different quality of service characteristics. A network entity, such as a base station, transmits semi-persistent scheduling (SPS) configurations to one or more other devices in the wireless communications system, such as a user equipment. An SPS configuration includes one or more discontinuous reception (DRX) timer configurations that the network entity can set according to any of the characteristics of one or more of the traffic flows. The network entity selects one or more timers, and appropriate values for those timers based on the characteristics of one or more of the traffic flows, configuring the SPS to support the requirements of the one or more traffic flows.

### RELATED APPLICATION

This application claims priority to U.S. Patent Application Ser. No. 63/407,015 filed Sep. 15, 2022 entitled “Semi-persistent Scheduling Configurations Including Timer Configurations,” the disclosure of which is incorporated by reference herein in its entirety.

### TECHNICAL FIELD

The present disclosure relates to wireless communications, and more specifically to including timer configurations in semi-persistent scheduling (SPS) configurations.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Devices in the wireless communications system can communicate with one another according using various different types of scheduling, one of which is SPS. SPS refers to communicating using resources that are assigned to a device for a particular amount of time, and this amount of time is repeated at a regular or set periodic rate.

### SUMMARY

The present disclosure relates to methods, apparatuses, and systems that support SPS configurations including timer configurations. The techniques discussed herein provide an efficient support of multiple traffic flows (e.g., data traffic flows) for various applications, such as extended reality (XR) applications. A network entity, such as a base station, transmits SPS configurations to one or more other devices, such as one or more UEs. These SPS configurations are optionally specific to XR. An SPS configuration includes one or more discontinuous reception (DRX) timer configurations that the network entity can set according to the quality of service (QoS) or other characteristics of the corresponding traffic flow. By applying an SPS configuration specific DRX timer configuration the network can efficiently support multi-flow XR applications with a single (e.g., a common) DRX scheme.

Some implementations of the method and apparatuses described herein may further include to: receive, from a network entity, a first signaling indicating a downlink semi-persistent scheduling (SPS) configuration, wherein the downlink SPS configuration includes a set of timer configurations; receive, from the network entity, a second signaling indicating a physical downlink shared channel (PDSCH) on an SPS transmission occasion of the downlink SPS configuration; and start, in response to receipt of the PDSCH on the SPS transmission occasion, a first timer that is set according to a corresponding timer value of the set of timer configurations.

In some implementations of the method and apparatuses described herein, the set of timer configurations includes a discontinuous reception (DRX) retransmission timer and a DRX hybrid automatic repeat request (HARQ) round trip time (RTT) timer. Additionally or alternatively, to start the first timer is to start a DRX HARQ timer configured in the SPS configuration in a first symbol after an end of a corresponding transmission carrying downlink HARQ feedback for the PDSCH. Additionally or alternatively, the set of timer configurations includes a DRX inactivity timer. Additionally or alternatively, to start the first timer is to start the DRX inactivity timer in response to receipt of the PDSCH on the SPS transmission occasion. Additionally or alternatively, the set of timer configurations includes a DRX On duration timer. Additionally or alternatively, the method and apparatus further start the DRX On duration timer for each SPS transmission occasion of the downlink SPS configuration. Additionally or alternatively, the method and apparatus further consider the SPS transmission occasion of the downlink SPS configuration as DRX ActiveTime and monitor a physical downlink control channel (PDCCH) at each SPS transmission occasion. Additionally or alternatively, multiple SPS transmission occasions are included in an SPS period, and the method and apparatus further assign, for each SPS occasion within the SPS period, a HARQ process identifier based at least in part on a number of SPS transmission occasions included in the SPS period and a current SPS transmission occasion. Additionally or alternatively, the first signaling comprises a radio resource control signaling. Additionally or alternatively, the apparatus comprises a user equipment.

Some implementations of the method and apparatuses described herein may further include to: transmit, to a UE a network entity, a first signaling indicating a downlink SPS configuration, wherein the downlink SPS configuration includes a set of timer configurations; transmit, to the UE, a second signaling indicating a PDSCH on an SPS transmission occasion of the downlink SPS configuration.

In some implementations of the method and apparatuses described herein, the set of timer configurations includes a DRX retransmission timer and a DRX HARQ RTT timer. Additionally or alternatively, the set of timer configurations includes a DRX inactivity timer. Additionally or alternatively, the set of timer configurations includes a DRX On duration timer. Additionally or alternatively, multiple SPS transmission occasions are included in an SPS period, and, for each SPS occasion within the SPS period, a HARQ process identifier is assigned to the SPS occasion based at least in part on a number of SPS transmission occasions included in the SPS period and a current SPS transmission occasion. Additionally or alternatively, the first signaling comprises a radio resource control signaling. Additionally or alternatively, the apparatus comprises a base station.

### BRIEF DESCRIPTION OF THE DRAWINGS

FIG. 1 illustrates an example of a wireless communications system that supports SPS configurations including timer configurations in accordance with aspects of the present disclosure.

FIG. 2 illustrates an example of multi-flow XR with DRX and SPS.

FIG. 3 illustrates an example flow of operations performed by the MAC entity when DRX is configured.

FIG. 4 illustrates an example of an SPS configuration information element (IE) that supports SPS configurations including timer configurations in accordance with aspects of the present disclosure.

FIG. 5 illustrates an example of using a DRX inactivity timer that supports SPS configurations including timer configurations in accordance with aspects of the present disclosure.

FIGS. 6 and 7 illustrate examples of SPS configuration IEs that supports SPS configurations including timer configurations in accordance with aspects of the present disclosure.

FIGS. 8 and 9 illustrate examples of block diagrams of devices that support SPS configurations including timer configurations in accordance with aspects of the present disclosure.

FIGS. 10 through 13 illustrate flowcharts of methods that support SPS configurations including timer configurations in accordance with aspects of the present disclosure.

### DETAILED DESCRIPTION

The present disclosure relates to methods, apparatuses, and systems that support SPS configurations including timer configurations. The techniques discussed herein provide an efficient support of multiple traffic flows (e.g., data traffic flows) for various applications, such as XR applications. Different ones of these multiple traffic flows can have different characteristics, such as different QoS characteristics. A network entity, such as a base station, transmits SPS configurations to one or more other devices in the wireless communications system, such as one or more UEs. An SPS configuration includes one or more DRX timer configurations that the network entity can set for the UE to use according to any of the characteristics of one or more of the traffic flows.

The DRX timer configurations include timer values for each of one or more timers at the UE. These timers can include, for example one or more of a DRX retransmission timer, a DRX HARQ RTT timer, a DRX inactivity timer, and a DRX On duration timer. The network entity selects one or more timers, and appropriate values for those timers based on the characteristics of one or more of the traffic flows, essentially configuring the SPS to support the requirements of the one or more traffic flows.

For some services, such as XR services, an application may be comprised of multiple traffic (e.g., data) flows with different traffic characteristics. One solution for supporting such services is using multiple simultaneous DRX configurations if a single DRX configuration matched to one flow does not satisfy the packet delay budgets (PDBs) of other flows, with each DRX configuration matching a traffic flow. Such a solution would be suitable to achieve both high UE power saving gains and many satisfied UEs. However, enabling multiple simultaneously active DRX configurations comes at the expense of a higher complexity and also requires further enhancements.

Another solution for supporting such services is SPS could be used to help schedule transmissions corresponding to different traffic flows in a timely manner when using a single DRX configuration. However, applying the same DRX configuration or timer values for each SPS configuration does not allow the DRX configuration to match the characteristics of the different traffic flows. For example, the DRX configuration may allow for a packet delay that exceeds the PDB of one of the flows.

Using the techniques discussed herein, SPS configuration specific DRX timer configurations allow the network to efficiently support multi-flow services, such as XR applications, with a single (e.g., a common) DRX scheme. This allows for having the same power efficiency or same power saving gains as if using a single DRX configuration, but that adapts to the different characteristics of the different flows. Furthermore, this avoids the complexity of implementing multiple simultaneous DRX configurations.

Aspects of the present disclosure are described in the context of a wireless communications system. Aspects of the present disclosure are further illustrated and described with reference to device diagrams and flowcharts.

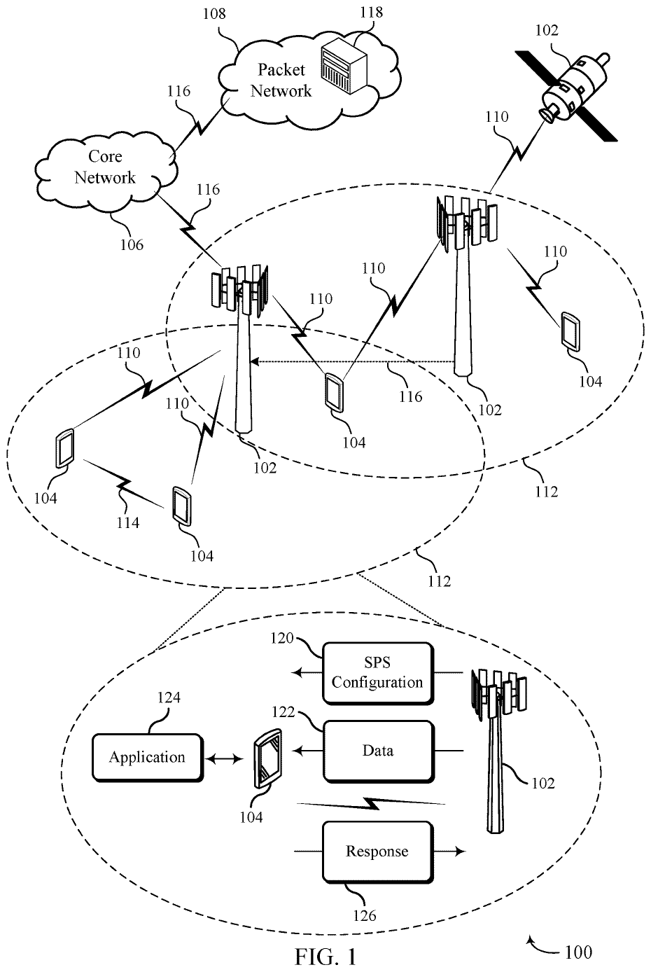

FIG. 1 illustrates an example of a wireless communications system 100 that supports SPS configurations including timer configurations in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network. equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A network entity 102 transmits a signaling to the UE 104, the signaling including an SPS configuration 120. The SPS configuration 120 may be transmitted using any of various different types of signaling, such as RRC signaling. The SPS configuration 120 includes one or more DRX timer configurations that the network entity sets for the UE 104 to use according to any of the characteristics of one or more of multiple downlink (DL) traffic flows, illustrated as data 122. The UE 104 receives the data 122 and an application 124 at the UE 104 uses the data 122. The application 124 may be any of a variety of applications, such as an XR application. The application 124 uses the one or more DRX timer configurations in the SPS configuration 120 to receive the data 122 and provide a response 126 (e.g., feedback) to the network entity 102 regarding receipt of the data 122. These timers can include, for example one or more of a DRX retransmission timer, a DRX HARQ RTT timer, a DRX inactivity timer, and a DRX On duration timer as discussed in more detail below.

In one or more implementations, the SPS configuration 120 is comprised of a set of timer configurations. For example, the SPS configuration 120 contains one or more information elements (IEs) that configure the value of a drx-RetransmissionTimerDL and or a drx-HARQ-RTT-TimerDL that is to be applied by the UE 104 for cases when a medium access control (MAC) protocol data unit (PDU) is received on an SPS occasion according to the SPS configuration 120.

Additionally or alternatively, the UE 104 considers an SPS transmission occasion of the SPS configuration 120 as DRX ActiveTime, e.g., the UE 104 monitors PDCCH at the SPS transmission occasions. The SPS configuration 120 configures by means of a new parameter or IE whether the UE 104 shall consider an SPS transmission occasion as ActiveTime for the SPS configuration 120, e.g., whether the UE 104 monitors PDCCH at the SPS occasions even though SPS is outside the DRX ActiveTime defined by the other drx timers/configuration.

Many end-user XR devices are expected to be power limited. Connected mode DRX (C-DRX) can be used to help such XR devices save power, and hence operate longer without needing to be charged. However, XR traffic characteristics, such as non-integer traffic periodicity, and jitter can result in missing an opportunity to schedule an XR video frame within an on-duration time of a DRX cycle. For instance, the video frame may arrive after the on-duration, and hence, needs to be scheduled in the next DRX cycle which in turn increases the associated latency. Such latency increase may not be desirable as XR packets need to be delivered within a delay budget otherwise, they may be useless.

For XR services where a XR application may be comprised of multiple flows with different traffic characteristics SPS could be used to help schedule transmission corresponding to different traffic in a timely manner when using a single DRX configuration. Multiple simultaneous DRX configurations, each matching a traffic flow, is suitable to achieve both high UE power saving gains and many satisfied UEs, if a single DRX configuration matched to one flow does not satisfy the PDBs of other flows. However, enabling multiple simultaneously active DRX configurations comes at the expense of a higher complexity and also requires further enhancements/standardization efforts.

By providing SPS occasions according to expected traffic arrivals. This would be an alternative to introducing multiple simultaneous DRX configurations. However, since different traffic flows/QoS flows have different traffic characteristics it would not be efficient to apply the same drx timer values for each SPS configuration, e.g., same drx-RetransmissionTimerDL or drx-HARQ-RTT-TimerDL value for each SPS configuration.

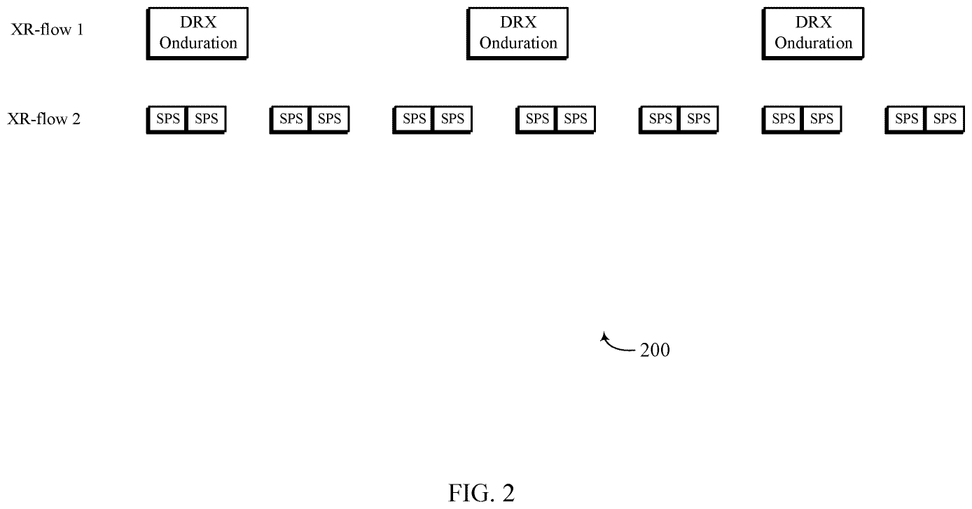

FIG. 2 illustrates an example 200 of multi-flow XR with DRX and SPS. In the top flow, XR-flow 1, the DRX Onduration boxes illustrate ActiveTime where the UE 104 monitors for the PDCCH. In the bottom flow, XR-flow 2, the SPS boxes illustrate times when the UE 104 will be awake and monitor for the PDSCH (e.g., data traffic). If the UE 104 receives a MAC PDU on an SPS transmission occasion, the UE 104 will then start a timer. For example, the UE 104 will start a drx-HARQ-RTT-TimerDL when it sends the HARQ feedback for this SPS transmission. Once this drx-HARQ-RTT-TimerDL expires, the UE 104 starts a drx-RetransmissionTimerDL timer in order to be able to monitor for further potential retransmissions.

XR is an umbrella term for different types of realities including virtual reality (VR), augmented reality (AR), and mixed reality (MR).

VR is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

AR is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

MR is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many of the XR and cloud gaming (CG) use cases are characterized by quasi-periodic traffic (with possible jitter) with high data rate in DL (i.e., video steam) combined with the frequent uplink (UL) (i.e., pose/control update) and/or UL video stream. Both DL and UL traffic are also characterized by relatively strict PDB.

The set of anticipated XR and CG services has a certain variety and characteristics of the data streams (i.e., video) may change “on-the-fly”, while the services are running over NR. Therefore, additional information on the running services from higher layers, e.g. the QoS flow association, frame-level QoS, application data unit (ADU)-based QoS, XR specific QoS, etc., may be beneficial to facilitate informed choices of radio parameters. The term ADU (application data unit) can be equally replaced by the term PDU set. It is clear that XR application awareness by the UE 104 and the network entity 102 would improve the user experience, improve the NR system capacity in supporting XR services, and reduce the UE power consumption.

An ADU or PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. An ADU or PDU set can be one or more I-slices, P-slices, I-frame, P-frame, or a combination of those.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

The latency requirement of XR traffic in RAN side (i.e., air interface) is modelled as PDB. The PDB is a limited time budget for a packet to be transmitted over the air from a network entity 102 to a UE 104.

For a given packet, the delay of the packet incurred in air interface is measured from the time that the packet arrives at the network entity 102 to the time that it is successfully transferred to the UE 104. If the delay is larger than a given PDB for the packet, then, the packet is said to violate PDB, otherwise the packet is said to be successfully delivered.

The value of PDB may vary for different applications and traffic types, which can be 10-20 ms depending on the application.

5G arrival time of data bursts on the downlink can be quasi periodic, i.e., periodic with jitter. Some of the factors leading to jitter in burst arrival include varying server render time, encoder time, real-time transport protocol (RTP) packetization time, link between server and 5G gateway, etc. 3rd Generation Partnership Project (3GPP) agreed simulation assumptions for XR evaluation model DL traffic arrival jitter using truncated Gaussian distribution with mean: 0 ms, std. dev: 2 ms, range: [−4 ms, 4 ms] (baseline), [−5 ms, 5 ms] (optional).

Applications can have a certain delay requirement on an ADU/PDU set that may not be adequately translated into packet delay budget requirements. For example, if the ADU delay budget (ADB) is 10 ms, then PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU. It is observed that specifying the ADB to the 5G system can be beneficial.

If the scheduler, and/or the UE 104 is aware of delay budgets for a packet/ADU, the network entity 102 can take this knowledge into account in scheduling transmissions, e.g., by giving priority to transmissions close to their delay budget limit, and by not scheduling (e.g., UL) transmissions; the UE 104 can also take advantage of such knowledge to determine 1) if an UL transmission (e.g., physical downlink control channel (PDCCH) in response to PDSCH, UL pose, or physical uplink shared channel (PUSCH)) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the network entity 102.

The remaining delay budget 1) for a DL transmission can be indicated to the UE 104 in a downlink control information (DCI) (e.g., for a packet of a video frame/slice/ADU) or via a MAC control element (MAC-CE) (e.g., for an ADU/video frame/slice) and 2) for an UL transmission can be indicated to the network entity 102 via an UL transmission such as uplink control information (UCI), PUSCH transmission, etc.

ADU-related QoS aspects of XR can be conveyed to the RAN to optimize the communication such as ADU error rate (AER), ADU delay budget (ADB), and ADU content policy (referred to as ADP, which is a percentage of packets/bits of an ADU to be received in order to correctly decode the ADU).

In one or more models, the packet arrival rate is determined by the frame generation rate, e.g., 60 fps. Accordingly, the average packet arrival periodicity is given by the inverse of the frame rate, e.g., 16.6667 ms=1/60 fps. The periodic arrival without jitter gives the arrival time at the network entity 102 for packet with index k (=1, 2, 3 . . . ) as

$$k / F * 1000 [ ms ] ,$$

where F is the given frame generation rates (per second).

Note that this periodic packet arrival implicitly assumes fixed delay contributed from network side including fixed video encoding time, fixed network transfer delay, etc.

However, in a real system, the varying frame encoding delay and network transfer time introduces jitter in packet arrival time at the network entity 102. In this model, the jitter is modelled as a random variable added on top of periodic arrivals. The jitter follows truncated Gaussian distribution with following statistical parameters shown in Table 1.

TABLE 1
Statistical parameters for jitter

| | | Baseline value for | Optional value for |
|---|---|---|---|
| Parameter | unit | evaluation | evaluation |
| Mean | ms | 0 | |
| Standard Deviation | ms | 2 | |
| (STD) | | | |
| Truncation range | ms | [−4, 4] | [−5, 5] |

Note that the given parameter values and considered frame generation rates (60 or 120 in this model) ensure that packet arrivals are in order (i.e., arrival time of a next packet is always larger than that of the previous packet).

Thus, the periodic arrival with jitter gives the arrival time for packet with index k (=1, 2, 3 . . . ) as

$$offset + k / F * 1000 + J [ ms ] ,$$

where F is the given frame generation rates (per second) and J is a random variable capturing jitter. Note that actual traffic arrival timing of traffic for each UE 104 could be shifted by the UE 104 specific arbitrary offset.

DRX functionality controls a UE's PDCCH monitoring activity for a MAC entity resulting in discontinuously monitoring PDCCH.

RRC signaling controls DRX operation by configuring the following parameters:
drx-onDurationTimer: the duration at the beginning of a DRX cycle (PDCCH is monitored within the on-duration);
drx-SlotOffset: the delay before starting the drx-onDurationTimer (e.g., with respect to a subframe boundary);
drx-InactivityTimer: the duration after the PDCCH occasion in which a PDCCH (received within DRX active time) indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer (after drx-SlotOffset from the beginning of the subframe) in case DCP (Downlink Control for Power saving) is monitored but not detected;
ps-TransmitOtherPeriodicCSI (optional): the configuration to report periodic channel state information (CSI) that is not L1-RSRP on PUCCH during the time duration indicated by drx-onDurationTimer in case DCP is configured but associated drx-onDurationTimer is not started;
ps-TransmitPeriodicLI-RSRP (optional): the configuration to transmit periodic CSI that is L1-RSRP on PUCCH during the time duration indicated by drx-onDurationTimer in case DCP is configured but associated drxonDurationTimer is not started;
uplinkHARQ-Mode (optional): the configuration to set the HARQ mode per UL HARQ process.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drxInactivityTimer. The DRX parameters that are common to the DRX groups are: drx-SlotOffset, drxRetransmissionTimerDL, drx-RetransmissionTimerUL, drx-LongCycleStartOffset, drx-ShortCycle (optional), drxShortCycleTimer (optional), drx-HARQ-RTT-TimerDL, drx-HARQ-RTT-TimerUL, and uplinkHARQ-Mode (optional).

The MAC entity may be configured by RRC with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in 3GPP technical specification (TS) 38.213.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per SL HARQ process): the maximum duration until a grant for SL retransmission is received;
drx-HARQ-RTT-TimerSL (per SL HARQ process): the minimum duration before an SL retransmission grant is expected by the MAC entity;
ps-Wakeup (optional): the configuration to start associated drx-onDurationTimer in case DCP is monitored but not detected;
ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
ps-TransmitPeriodicLI-RSRP (optional): the configuration to transmit periodic CSI that is L1-RSRP on PUCCH during the time duration indicated by drx-onDurationTimer in case DCP is configured but associated drx-onDurationTimer is not started;
downlinkHARQ-FeedbackDisabled (optional): the configuration to enable HARQ feedback per DL HARQ process;
uplinkHARQ-Mode (optional): the configuration to set HARQmodeA or HARQmodeB per UL HARQ process.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional).

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in 3GPP TS 38.321, section 5.7, clause 5.1.5) or msgB-ResponseWindow (as described in clause 5.1.4a) is running; or
a Scheduling Request is sent on PUCCH and is pending (as described in 3GPP TS 38.321, section 5.7, clause 5.4.4 or 5.22.1.5). If this Serving Cell is part of a non-terrestrial network, the Active Time is started after the Scheduling Request transmission that is performed when the SR COUNTER is 0 for all the SR configurations with pending SR(s) plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in 3GPP TS 38.321, section 5.7, clauses 5.1.4 and 5.1.4a).

The following MAC timers are used for DRX operation in a non-terrestrial network:
HARQ-RTT-TimerDL-NTN (per DL HARQ process configured with HARQ feedback enabled): the minimum duration before a DL assignment for HARQ retransmission is expected by the MAC entity;
HARQ-RTT-TimerUL-NTN (per UL HARQ process configured with HARQModeA): the minimum duration before a UL HARQ retransmission grant is expected by the MAC entity.

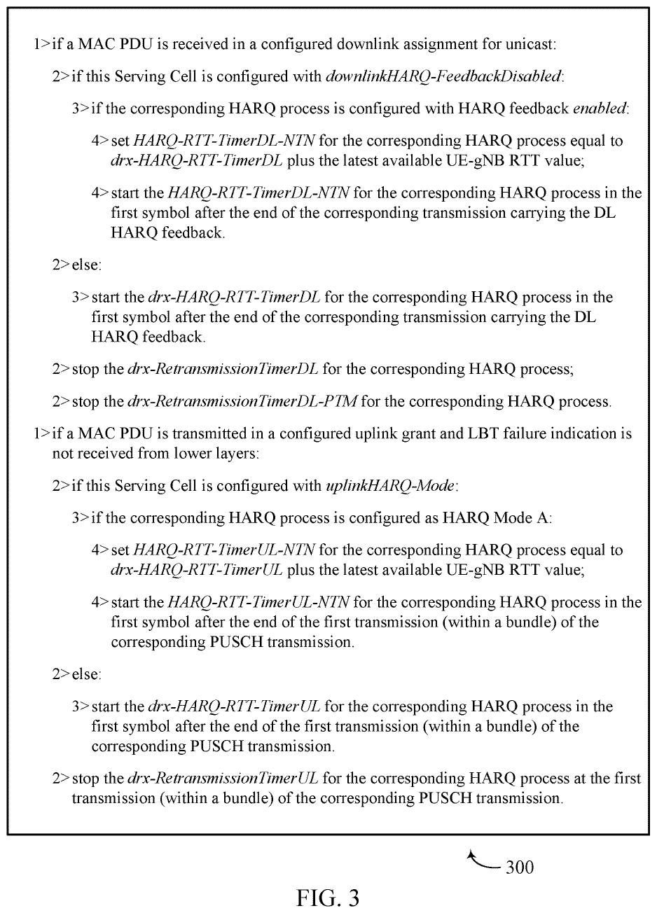

FIG. 3 illustrates an example flow of operations 300 performed by the MAC entity when DRX is configured. The operations 300 are illustrated, for example, in pseudocode.

For NR, the UE 104 monitors PDCCH for potential HARQ retransmissions in case a PDSCH is received on an SPS occasion, even if the SPS occasion (configured downlink assignment) is not within the ActiveTime. Similar behavior has been specified for configured uplink grants, i.e., CG grants.

In one or more implementations, an SPS configuration is comprised of a set of timer configurations. For example, an SPS configuration may contain IE(s) which configure the value of a drx-RetransmissionTimerDL and or drx-HARQ-RTT-TimerDL that is to be applied by the UE for cases when a MAC PDU is received on an SPS occasion according to the SPS configuration. The drx-RetransmissionTimerDL may also be referred to as a DRX retransmission timer, and the drx-HARQ-RTT-TimerDL may also be referred to as a HARQ RTT timer.

In one example, the UE starts the drx-HARQ-RTT-TimerDL which is set to the value as configured in the SPS configuration IE for the corresponding HARQ process in the first symbol after the end of the corresponding transmission carrying the DL HARQ feedback when a PDSCH/MAC PDU is received on an SPS occasion of the corresponding SPS configuration. Similarly, the UE starts the drx-RetransmissionTimerDL set to the value as configured for the SPS configuration upon expiry of the drx-HARQ-RTT-TimerDL.

The drx-RetransmissionTimerDL may be started upon expiry of the drx-HARQ-RTT-TimerDL regardless of whether the PDSCH could be correctly decoded or not, e.g. NACK or ACK is reported as HARQ feedback.

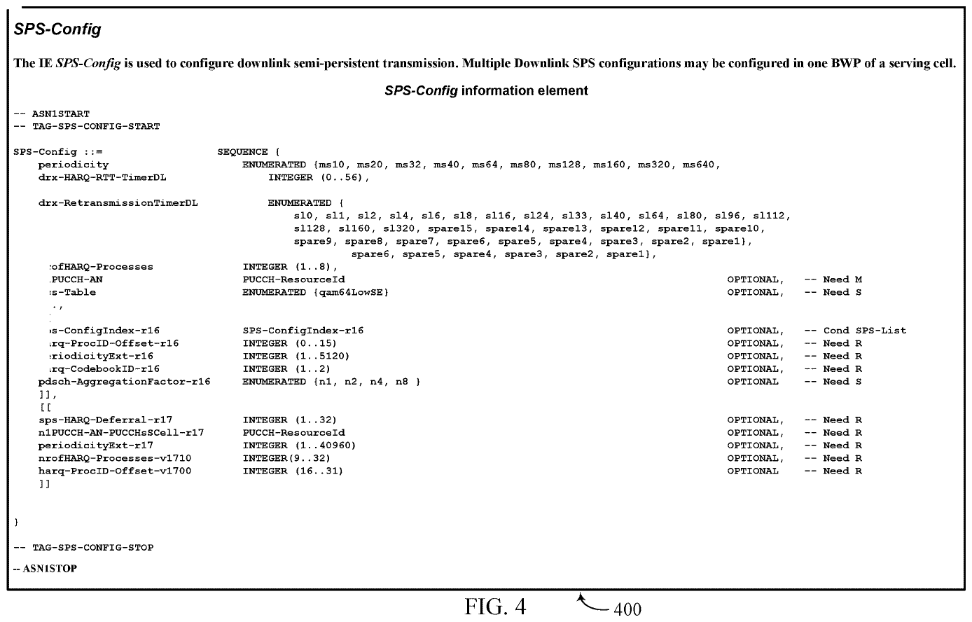

FIG. 4 illustrates an example of SPS configuration IE 400 that supports SPS configurations including timer configurations in accordance with aspects of the present disclosure. As illustrated, the SPS configuration IE 400 includes the drx-HARQ-RTT-TimerDL, which may have an integer value, and the drx-RetransmissionTimerDL set to the value as configured for the SPS configuration upon expiry of the drx-HARQ-RTT-TimerDL which may have one of multiple enumerated values.

Returning to FIG. 1, in one or more implementations an SPS configuration is comprised of a drx-inactivity Timer configuration (also referred to as a DRX inactivity timer or drx-InactivityTimer). In one example, the UE starts the drx-InactivityTimer for cases when a PDSCH is received on an SPS occasion of the SPS occasion. The drx-InactivityTimer may be set to the value configured for the corresponding SPS configuration. The drx-InactivityTimer may be started at a preconfigured Offset after an SPS transmission occasion in order to consider the MAC processing delay, e.g., detection/decoding of PDSCH on the SPS transmission occasion. In one example the time offset is configured in the SPS configuration.

Starting the drx-InactivityTimer ensures that there is no long period of DRX (“sleep period”) between the SPS transmission occasion and the subsequent ActiveTime triggered by the starting of the drx-Retransmission TimerDL.

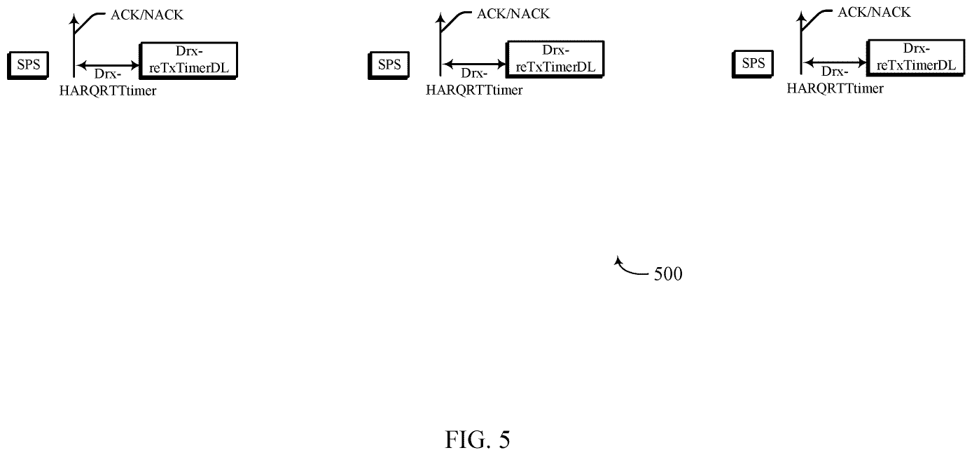

FIG. 5 illustrates an example 500 of using a DRX inactivity timer that supports SPS configurations including timer configurations in accordance with aspects of the present disclosure. As shown in the example 500, the network would need to wait until the expiry of the drx-HARQ-RTT-TimerDL timer before being able to schedule further DL/UL transmission to the UE, e.g., the UE is in ActiveTime and monitoring PDCCH while the drx-RetransmissionTimerDL is running. Therefore, starting the drx-InactivityTimer, e.g., if configured in the corresponding SPS configuration, in response to the reception of a PDSCH on an SPS transmission occasion allows the network to, for example, schedule subsequently (without a gap) further DL packets of the DL data burst/PDU set.

In one or more implementations, the UE is only required to monitor PDCCH for DL DCIs while the drx-InactivityTimer that was started in response to the reception of a PDSCH on an SPS transmission occasion is running.

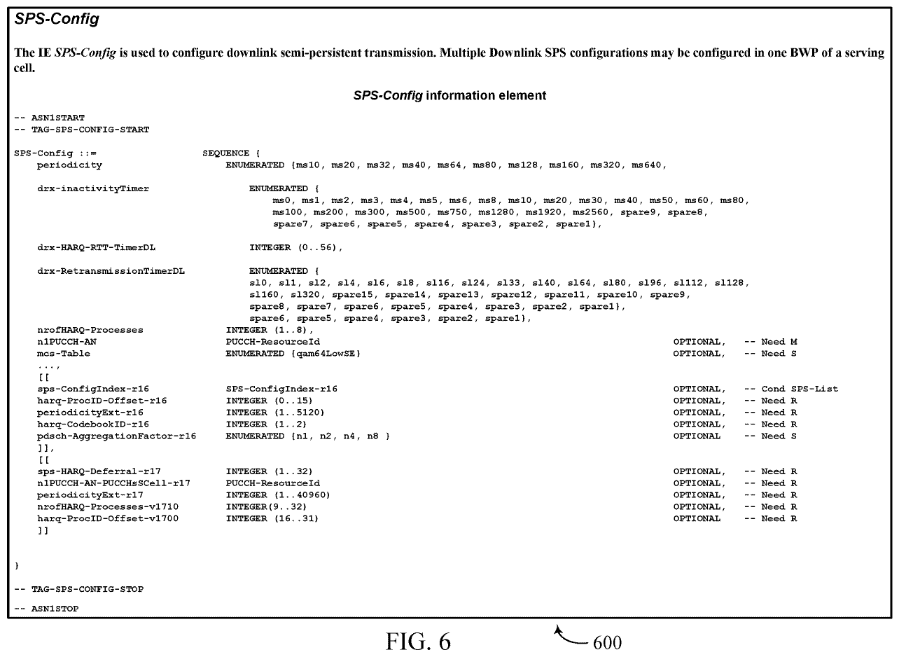

FIG. 6 illustrates an example of SPS configuration IE 600 that supports SPS configurations including timer configurations in accordance with aspects of the present disclosure. As illustrated, the SPS configuration IE 600 includes the drx-HARQ-RTT-TimerDL and the drx-RetransmissionTimerDL, as in the SPS configuration IE 400 of FIG. 4. The SPS configuration IE 600 also includes the drx-InactivityTimer which may have one of multiple enumerated values.

In one or more implementations, an SPS configuration is comprised of a drx-OndurationTimer configuration. The drx-OndurationTimer may also be referred to as a DRX On duration timer. In one example, the UE starts the drx-OndurationTimer, if configured within the SPS configuration, for every SPS transmission occasion of the SPS configuration. E.g., the UE starts the drx-OndurationTimer at the beginning of the slot, symbol, or subframe of the SPS transmission occasions.

In one example, an SPS configuration contains a drx-OndurationTimer configuration as well as a drx-HARQ-RTT-timerDL and drx-retransmissionTimerDL configuration. The UE starts the drx-OndurationTimer at the beginning of the slot, symbol, or subframe of the SPS transmission occasion. In response to the reception of a PDSCH on a SPS transmission occasion the UE starts the drx-HARQ-RTT-timerDL in the first symbol after the end of the corresponding transmission carrying the DL HARQ feedback.

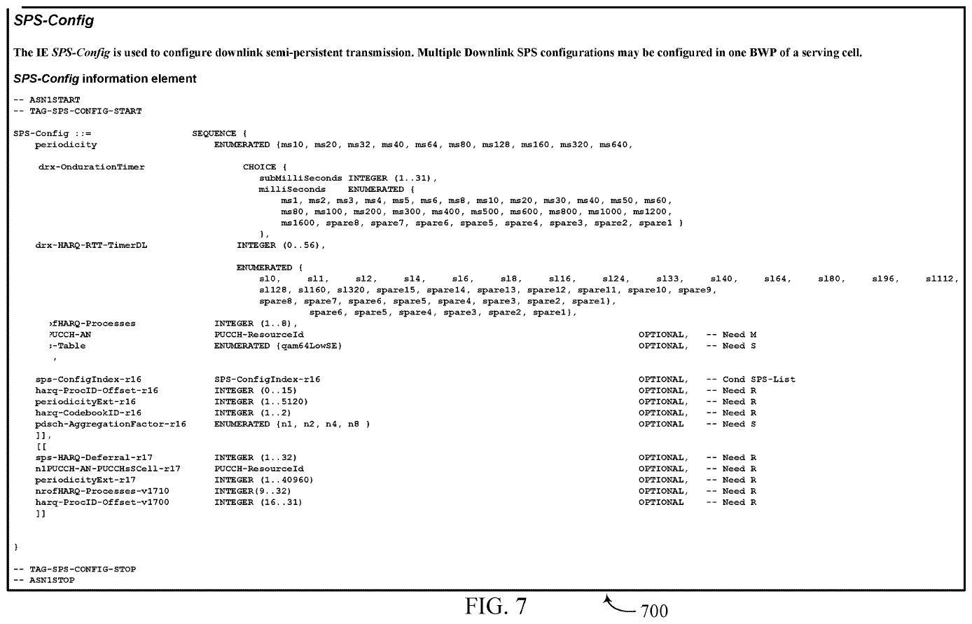

FIG. 7 illustrates an example of SPS configuration IE 700 that supports SPS configurations including timer configurations in accordance with aspects of the present disclosure. As illustrated, the SPS configuration IE 700 includes the drx-HARQ-RTT-TimerDL and the drx-RetransmissionTimerDL, as in the SPS configuration IE 400 of FIG. 4. The SPS configuration IE 700 also includes the drx-OndurationTimer which may have one of multiple enumerated values.

Returning to FIG. 1, the techniques discussed herein address the HARQ process determination for a case that the SPS configuration has multiple SPS occasions per SPS period. In order to avoid a gap between an SPS occasion and the subsequent Active Time of the UE triggered by the starting of the drx-retransmissionTimerDL, one SPS configuration may be comprised of multiple SPS transmission occasions within one SPS period. However, supporting more than one SPS transmission occasions within a SPS period, would require a new UE behavior for the association of SPS transmission occasions to HARQ process IDs. With the current formula all SPS occasions within one SPS period will be assigned the same HARQ process ID as follows.

For configured downlink assignments without harq-ProcID-Offset, the HARQ Process ID associated with the slot where the DL transmission starts is derived from the following equation:

$$HARQ Process ID = [ floor ( CURRENT\_slot \times 10 / ( numberOfSlotsPerFrame \times periodicity ) ) ] modulo nrofHARQ - Processes$$

where CURRENT_slot=[(SFN×numberOfSlotsPerFrame)+slot number in the frame] and numberOfSlotsPerFrame refers to the number of consecutive slots per frame as specified in 3GPP TS 38.211.

For configured downlink assignments with harq-ProcID-Offset, the HARQ Process ID associated with the slot where the DL transmission starts is derived from the following equation:

$$HARQ Process ID = [ floor ( CURRENT\_slot \times 10 / ( numberOfSlotsPerFrame \times periodicity ) ) ] modulo nrofHARQ - Processes + harq - ProcID - Offset$$

where CURRENT_slot=[(SFN×numberOfSlotsPerFrame)+slot number in the frame] and numberOfSlotsPerFrame refers to the number of consecutive slots per frame as specified in 3GPP TS 38.211.

In the case of unaligned system frame number (SFN) across carriers in a cell group, the SFN of the concerned Serving Cell is used to calculate the HARQ Process ID used for configured downlink assignments.

Note that CURRENT_slot refers to the slot index of the first transmission occasion of a bundle of configured downlink assignment.

In one or more implementations, a pattern is defined which defines the SPS occasions within a SPS period. The pattern is repeated with the defined periodicity. In one example the pattern is defined as a bitmap, whereby the first bit of the bitmap corresponds to the first SPS occasion within an SPS period.

A new formula may assign a HARQ process ID to an SPS occasion. The new formula is in one example:

$$HARQ Process ID = [ [ floor ( CURRENT\_slot \times 10 / ( numberOfSlotsPerFrame \times periodicity ) ) ] \times numberOfSPSoccasionPerPeriod + CURRENT\_SPSoccasion ] modulo nrofHARQ - Processes$$

where numberOfSPSoccasionsPerPeriod refers to the number of SPS transmission occasions within one SPS period and CURRENT_SPSoccasion refers to the index of the SPS transmission occasion within a SPS period for which an HARQ Process ID should be assigned. CURRENT_slot refers to the slot index of the first transmission occasion of a set of configured downlink assignments within a SPS period.

In one or more implementations, the UE considers an SPS transmission occasion of an SPS configuration as DRX ActiveTime, e.g., the UE monitors PDCCH at the SPS transmission occasions. This allows the network (e.g., network entity 102) to override SPS allocations by issuing a dynamic grant (DG). In one example, an SPS configuration configures by means of a new parameter or IE whether the UE shall consider an SPS transmission occasion as ActiveTime for an SPS configuration, e.g., whether the UE monitors PDCCH at the SPS occasions even though SPS is outside the DRX ActiveTime defined by the other drx timers or configuration. The benefit would be that the network could always update or override the SPS grant even for cases when the SPS occasion is not within the DRX ActiveTime. Since XR traffic has variable packet sizes this provides more flexibility to the network or scheduler. It will also allow the network to make the UE start the drx-inactivityTimer, e.g. for cases when there are more transmissions necessary in order to transmit the DL data pending in the buffer in the network. Whenever the network sends a DCI on the SPS transmission occasion the UE will start the drx-inactivity Timer which extends the ActiveTime. The drx-inactivity Timer value is according to one implementation configured for the SPS configuration. The UE uses the configured drx-inactivity Timer value for cases when a DCI received on a SPS transmission occasion. In one example the UE applies legacy behavior for cases that the SPS transmission occasion falls within the ActiveTime, e.g., different UE behavior with respect to DRX timer handling depending on whether the SPS occasion falls within the UE's ActiveTime or not.

In one or more implementations, a CG configuration is configured with the maximum number of supported HARQ retransmissions for the corresponding PUSCH transmission associated with the CG configuration.

In one example, the UE shall only start the drx-HARQ-RTT-TimerUL after a PUSCH transmission, and subsequently the drx-RetransmissionTimer (IL, in case the number of HARQ retransmissions is not equal to or larger than the configured maximum number of supported retransmissions. For example, for cases when the maximum number of supported HARQ retransmissions for a CG configuration is configured to be equal to 1, the UE shall only start the drx-HARQ-RTT-TimerUL in response to the initial HARQ transmission on the CG resource, e.g., the UE shall not start the drx-HARQ-RTT-TimerUL after having performed the first retransmission of a CG PUSCH transmission.

In one or more implementations, an UL DCI includes an indication which indicates whether the UE should start the drx-HARQ-RTT-TimerUL in response to a PUSCH transmission on an UL CG resource. In one example, the UL DCI is a DCI which activates a CG configuration, e.g. PDCCH addressed to CS-RNTI. The information on whether to start the drx-HARQ-RTT-TimerUL following a PUSCH transmission on CG UL resources may be signaled within a one-bit field in the DCI. In one example if the one-bit field within the DCI activating a CG configuration is set to ‘0’, the UE doesn't start the drx-HARQ-RTT-TimerUL, and subsequently the drx-RetransmissionTimer UL, upon having performed a PUSCH transmission on the UL CG resources activated by the UL CG activation DCI. Similarly, if the one-bit field within the DCI activating a CG configuration is set to ‘1’, the UE starts the drx-HARQ-RTT-TimerUL, and subsequently the drx-RetransmissionTimer UL, upon having performed a PUSCH transmission on the UL CG resources activated by the UL CG activation DCI. In one example, the indication or field within the UL DCI is a new field, i.e. new DCI format for activating or deactivating an UL CG is introduced. According to another example, an existing field or a combination of existing fields within the DCI used for the activation or deactivation of an UL CG is reused or repurposed in order to indicate whether drx-HARQ-RTT-TimerUL shall be started following a PUSCH transmission on UL CG resource.

In one or more implementations, a MAC control element whether the UE shall start the drx-HARQ-RTT-TimerUL following a PUSCH transmission on a CG UL resources. In one example, the MAC CE indicates for each configured UL CG configuration whether UE shall start the drx-HARQ-RTT-TimerUL following a PUSCH transmission on the corresponding CG UL resources. The MAC CE may be comprised of a bitmap, where each field of the bitmap corresponds to a configured UL CG configuration. In one example a bit of the bitmap set to ‘1’ indicates that the UE shall start the drx-HARQ-RTT-TimerUL following a PUSCH on the CG PUSCH resources of the corresponding CG configuration. The bit set to ‘0’ indicates that the UE shall not start the drx-HARQ-RTT-TimerUL following a PUSCH on the CG PUSCH resources of the corresponding CG configuration.

The techniques discussed herein thus include various different aspects of SPS configurations including timer configurations. For example, an SPS configuration is comprised of drx related timer configurations. In one or more implementations, the Drx timer configuration is one of or combination of: drx-HARQ-RTT-timerDL, drx-retransmissionTimerDL, drx-Onduration Timer, and dr-InactivityTimer. Additionally or alternatively, the UE 104 starts drx-HARQ-RTT-timerDL, in the first symbol after the end of the HARQ feedback transmission for a PDSCH received on a SPS transmission occasion. Additionally or alternatively, the UE 104 starts dr-InactivityTimer in response to a PDSCH reception on a SPS transmission occasion. Additionally or alternatively, the UE 104 starts drx-OndurationTimer for each SPS transmission occasion of a SPS configuration. Additionally or alternatively, the UE 104 considers the SPS transmission occasion of a SPS configuration as DRX ActiveTime. Additionally or alternatively, a new formula or rule for the determination of a HARQ process ID corresponding to a SPS transmission occasion is introduced for cases when there are multiple SPS transmission occasion within a SPS period.

In some solutions, the network would either use a single DRX scheme with SPS configurations or a system with multiple simultaneously active DRX configurations. Using a single DRX scheme with SPS configuration does not allow to efficiently support the multiple flow XR applications for power saving perspective, since same DRX timer configuration is applied for each traffic flow. On the other hand, the support of multiple active DRX configurations increases the UE complexity and requires further enhancements. Using the techniques discussed herein provides some SPS enhancements which allow for an efficient support of multi-flow XR applications while still using a single DRX scheme.

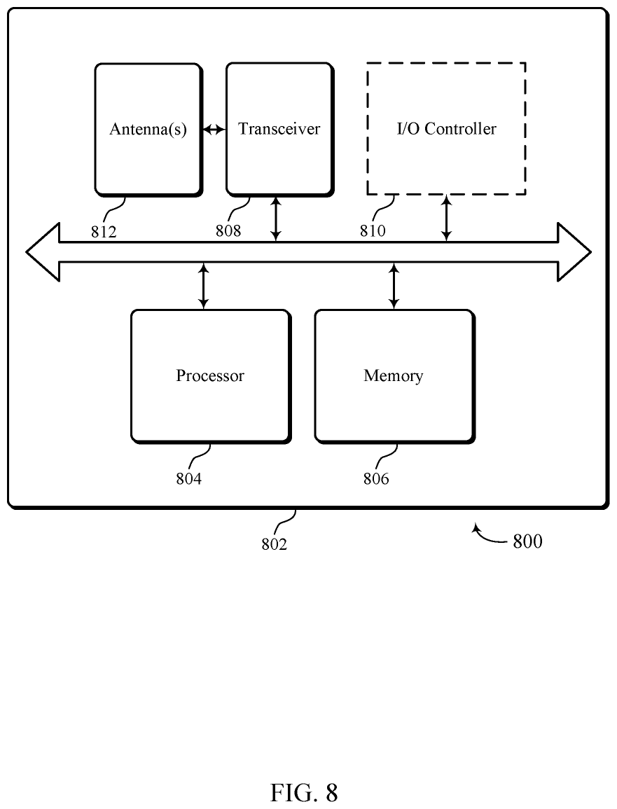

FIG. 8 illustrates an example of a block diagram 800 of a device 802 that supports SPS configurations including timer configurations in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support to: receive, from a network entity, a first signaling indicating a downlink SPS configuration, where the downlink SPS configuration includes a set of timer configurations; receive, from the network entity, a second signaling indicating a PDSCH on an SPS transmission occasion of the downlink SPS configuration; and start, in response to receipt of the PDSCH on the SPS transmission occasion, a first timer that is set according to a corresponding timer value of the set of timer configurations.

Additionally or alternatively, the processor 804 may be configured to or otherwise support: where the set of timer configurations includes a DRX retransmission timer and a DRX HARQ RTT timer; where to start the first timer is to start a DRX HARQ timer configured in the SPS configuration in a first symbol after an end of a corresponding transmission carrying downlink HARQ feedback for the PDSCH; where the set of timer configurations includes a DRX inactivity timer; where to start the first timer is to start the DRX inactivity timer in response to receipt of the PDSCH on the SPS transmission occasion; where the set of timer configurations includes a DRX On duration timer; where the processor is further configured to start the DRX On duration timer for each SPS transmission occasion of the downlink SPS configuration; where the processor is further configured to consider the SPS transmission occasion of the downlink SPS configuration as DRX ActiveTime and monitor a PDCCH at each SPS transmission occasion; where multiple SPS transmission occasions are included in an SPS period, and where the processor is further configured to assign, for each SPS occasion within the SPS period, a HARQ process identifier based at least in part on a number of SPS transmission occasions included in the SPS period and a current SPS transmission occasion; where the first signaling comprises a radio resource control signaling; where the apparatus comprises a user equipment.

For example, the processor 804 may support wireless communication at the device 802 in accordance with examples as disclosed herein. Processor 804 may be configured as or otherwise support a means for receiving, from a network entity, a first signaling indicating a downlink SPS configuration, where the downlink SPS configuration includes a set of timer configurations; receiving, from the network entity, a second signaling indicating a PDSCH on an SPS transmission occasion of the downlink SPS configuration; and starting, in response to receipt of the PDSCH on the SPS transmission occasion, a first timer that is set according to a corresponding timer value of the set of timer configurations.

The processor 804 of the device 802, such as a UE 104, may support wireless communication in accordance with examples as disclosed herein. The processor 804 includes at least one controller coupled with at least one memory, and is configured to or operable to cause the processor to: receive, from a network entity, a first signaling indicating a downlink SPS configuration, wherein the downlink SPS configuration includes a set of timer configurations; receive, from the network entity, a second signaling indicating a PDSCH on an SPS transmission occasion of the downlink SPS configuration; and start, in response to receipt of the PDSCH on the SPS transmission occasion, a first timer that is set according to a corresponding timer value of the set of timer configurations.

Additionally or alternatively, the processor 804 may be configured to or otherwise support: where the set of timer configurations includes a DRX retransmission timer and a DRX HARQ RTT timer; where starting the first timer comprises starting a DRX HARQ timer configured in the SPS configuration in a first symbol after an end of a corresponding transmission carrying downlink HARQ feedback for the PDSCH; where the set of timer configurations includes a DRX inactivity timer; where starting the timer comprises starting the DRX inactivity timer in response to receipt of the PDSCH on the SPS transmission occasion; where the set of timer configurations includes a DRX On duration timer; starting the DRX On duration timer for each SPS transmission occasion of the downlink SPS configuration; considering the SPS transmission occasion of the downlink SPS configuration as DRX ActiveTime and monitor a PDCCH at each SPS transmission occasion; where multiple SPS transmission occasions are included in an SPS period, and further assigning, for each SPS occasion within the SPS period, a HARQ process identifier based at least in part on a number of SPS transmission occasions included in the SPS period and a current SPS transmission occasion; where the first signaling comprises a radio resource control signaling; where the method is implemented in a user equipment.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

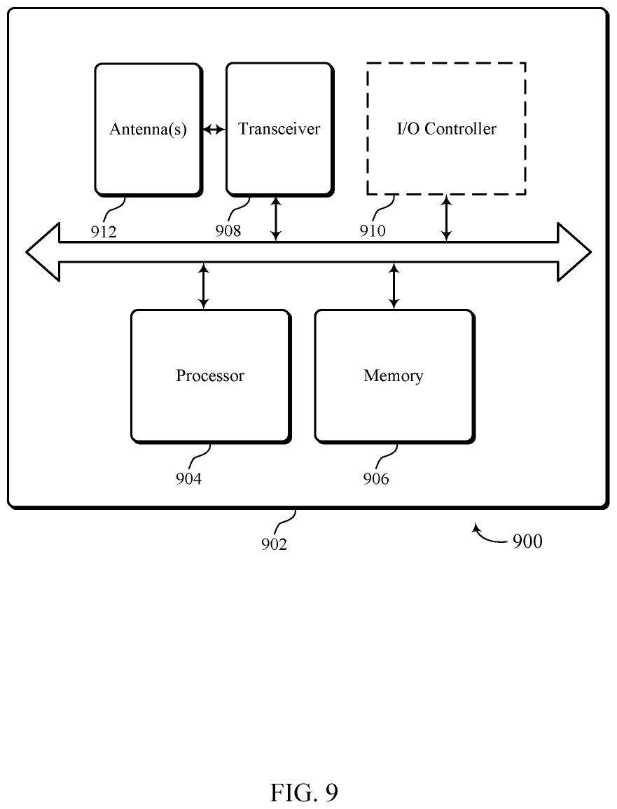

FIG. 9 illustrates an example of a block diagram 900 of a device 902 that supports SPS configurations including timer configurations in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support to: transmit, to a UE a network entity, a first signaling indicating a downlink SPS configuration, where the downlink SPS configuration includes a set of timer configurations; transmit, to the UE, a second signaling indicating a PDSCH on an SPS transmission occasion of the downlink SPS configuration.

Additionally or alternatively, the processor 904 may be configured to or otherwise support: where the set of timer configurations includes a DRX retransmission timer and a DRX HARQ RTT timer; where the set of timer configurations includes a DRX inactivity timer; where the set of timer configurations includes a DRX On duration timer; where multiple SPS transmission occasions are included in an SPS period, and where, for each SPS occasion within the SPS period, a HARQ process identifier is assigned to the SPS occasion based at least in part on a number of SPS transmission occasions included in the SPS period and a current SPS transmission occasion; where the first signaling comprises a radio resource control signaling; where the apparatus comprises a base station.

For example, the processor 904 may support wireless communication at the device 902 in accordance with examples as disclosed herein. Processor 904 may be configured as or otherwise support a means for transmitting, to a UE a network entity, a first signaling indicating a downlink SPS configuration, where the downlink SPS configuration includes a set of timer configurations; and transmitting, to the UE, a second signaling indicating a PDSCH on an SPS transmission occasion of the downlink SPS configuration.

Additionally or alternatively, the processor 904 may be configured to or otherwise support: where the set of timer configurations includes a DRX retransmission timer and a DRX HARQ RTT timer; where the set of timer configurations includes a DRX inactivity timer; where the set of timer configurations includes a DRX On duration timer; where multiple SPS transmission occasions are included in an SPS period, and where, for each SPS occasion within the SPS period, a HARQ process identifier is assigned to the SPS occasion based at least in part on a number of SPS transmission occasions included in the SPS period and a current SPS transmission occasion; where the first signaling comprises a radio resource control signaling; where the method is implemented in a base station.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

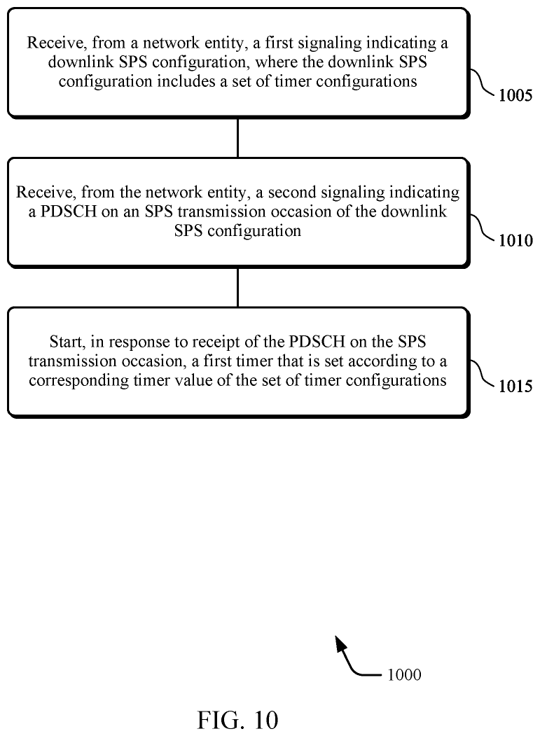

FIG. 10 illustrates a flowchart of a method 1000 that supports SPS configurations including timer configurations in accordance with aspects of the present disclosure. The operations of the method 1000 may be implemented by a device or its components as described herein. For example, the operations of the method 1000 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1005, the method may include receiving, from a network entity, a first signaling indicating a downlink SPS configuration, where the downlink SPS configuration includes a set of timer configurations. The operations of 1005 may be performed in accordance with examples as described herein. In some implementations, aspects of the operations of 1005 may be performed by a device as described with reference to FIG. 1.

At 1010, the method may include receiving, from the network entity, a second signaling indicating a PDSCH on an SPS transmission occasion of the downlink SPS configuration. The operations of 1010 may be performed in accordance with examples as described herein. In some implementations, aspects of the operations of 1010 may be performed by a device as described with reference to FIG. 1.

At 1015, the method may include starting, in response to receipt of the PDSCH on the SPS transmission occasion, a first timer that is set according to a corresponding timer value of the set of timer configurations. The operations of 1015 may be performed in accordance with examples as described herein. In some implementations, aspects of the operations of 1015 may be performed by a device as described with reference to FIG. 1.

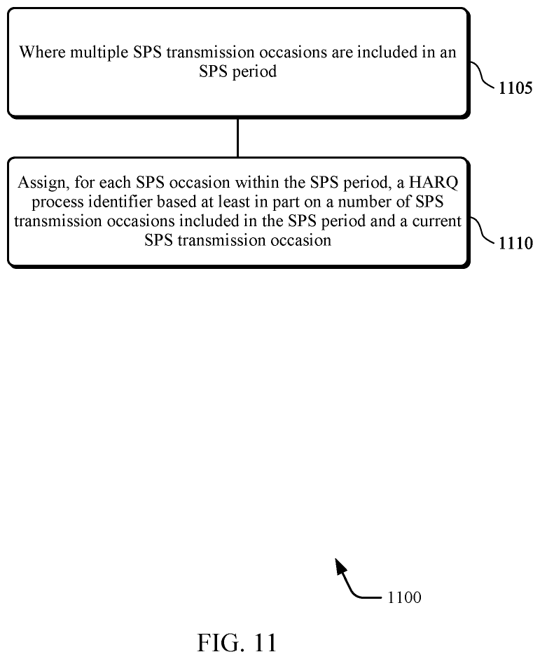

FIG. 11 illustrates a flowchart of a method 1100 that supports SPS configurations including timer configurations in accordance with aspects of the present disclosure. The operations of the method 1100 may be implemented by a device or its components as described herein. For example, the operations of the method 1100 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1105, the method may include where multiple SPS transmission occasions are included in an SPS period. The operations of 1105 may be performed in accordance with examples as described herein. In some implementations, aspects of the operations of 1105 may be performed by a device as described with reference to FIG. 1.

At 1110, the method may include assigning, for each SPS occasion within the SPS period, a HARQ process identifier based at least in part on a number of SPS transmission occasions included in the SPS period and a current SPS transmission occasion. The operations of 1110 may be performed in accordance with examples as described herein. In some implementations, aspects of the operations of 1110 may be performed by a device as described with reference to FIG. 1.

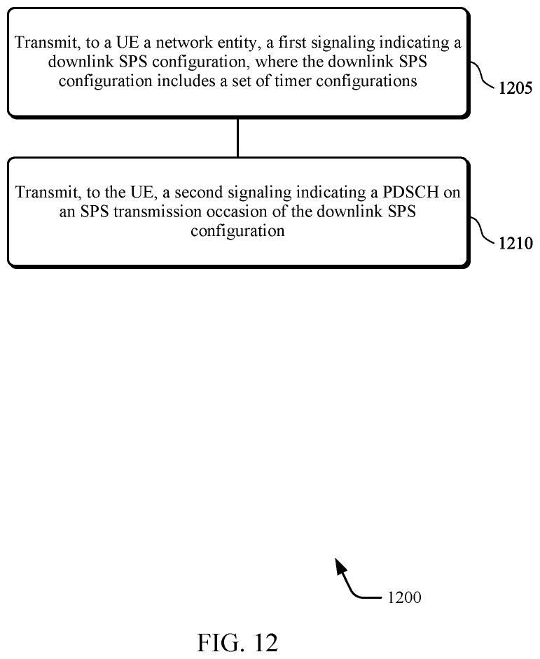

FIG. 12 illustrates a flowchart of a method 1200 that supports SPS configurations including timer configurations in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1205, the method may include transmitting, to a UE a network entity, a first signaling indicating a downlink SPS configuration, where the downlink SPS configuration includes a set of timer configurations. The operations of 1205 may be performed in accordance with examples as described herein. In some implementations, aspects of the operations of 1205 may be performed by a device as described with reference to FIG. 1.

At 1210, the method may include transmitting, to the UE, a second signaling indicating a PDSCH on an SPS transmission occasion of the downlink SPS configuration. The operations of 1210 may be performed in accordance with examples as described herein. In some implementations, aspects of the operations of 1210 may be performed by a device as described with reference to FIG. 1.

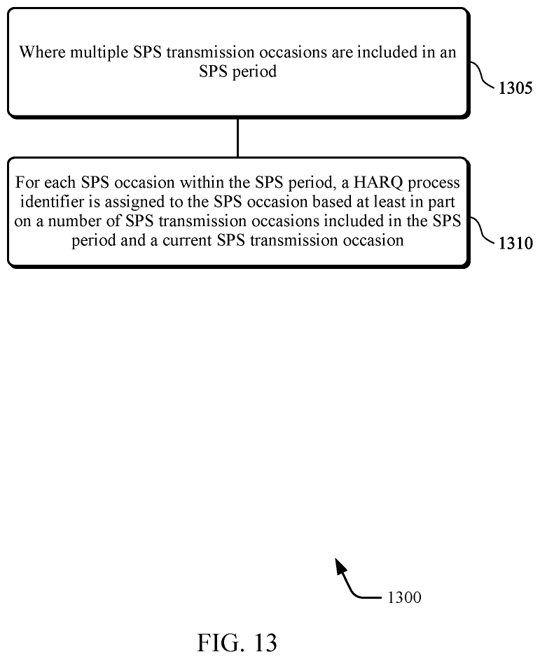

FIG. 13 illustrates a flowchart of a method 1300 that supports SPS configurations including timer configurations in accordance with aspects of the present disclosure. The operations of the method 1300 may be implemented by a device or its components as described herein. For example, the operations of the method 1300 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1305, the method may include where multiple SPS transmission occasions are included in an SPS period. The operations of 1305 may be performed in accordance with examples as described herein. In some implementations, aspects of the operations of 1305 may be performed by a device as described with reference to FIG. 1.

At 1310, the method may include for each SPS occasion within the SPS period, a HARQ process identifier is assigned to the SPS occasion based at least in part on a number of SPS transmission occasions included in the SPS period and a current SPS transmission occasion. The operations of 1310 may be performed in accordance with examples as described herein. In some implementations, aspects of the operations of 1310 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a downlink semi-persistent scheduling (SPS) configuration, wherein the downlink SPS configuration includes a set of timer configurations;
receive a physical downlink shared channel (PDSCH) on an SPS transmission occasion of the downlink SPS configuration; and
start, based at least in part on receipt of the PDSCH on the SPS transmission occasion, a first timer that is set according to a corresponding timer value of the set of timer configurations.

2. The UE of claim 1, wherein the set of timer configurations includes a discontinuous reception (DRX) retransmission timer and a DRX hybrid automatic repeat request (HARQ) round trip time (RTT) timer.

3. The UE of claim 1, wherein to start the first timer, the at least one processor is further operable to cause the UE to start a DRX hybrid automatic repeat request (HARQ) timer configured in the SPS configuration in a first symbol after an end of a corresponding transmission carrying downlink HARQ feedback for the PDSCH.

4. The UE of claim 1, wherein the set of timer configurations includes a discontinuous reception (DRX) inactivity timer.

5. The UE of claim 4, wherein to start the first timer, the at least one processor is further operable to cause the UE to start the DRX inactivity timer in response to receipt of the PDSCH on the SPS transmission occasion.

6. The UE of claim 1, wherein the set of timer configurations includes a discontinuous reception (DRX) On duration timer.

7. The UE of claim 6, wherein the at least one processor is further operable to cause the UE to start the DRX On duration timer for each SPS transmission occasion of the downlink SPS configuration.

8. The UE of claim 1, wherein the at least one processor is further operable to cause the UE to:
consider the SPS transmission occasion of the downlink SPS configuration as discontinuous reception (DRX) ActiveTime; and
monitor a physical downlink control channel (PDCCH) at each SPS transmission occasion.

9. The UE of claim 1, wherein multiple SPS transmission occasions are included in an SPS period, and wherein the at least one processor is further operable to cause the UE to assign, for each SPS occasion within the SPS period, a hybrid automatic repeat request (HARQ) process identifier based at least in part on a number of SPS transmission occasions included in the SPS period and a current SPS transmission occasion.

10. The UE of claim 1, wherein to receive the downlink SPS configuration, the at least one processor is further operable to cause the UE to receive the downlink SPS configuration via a radio resource control signaling.

11. A base station for wireless communication, comprising:
at least one memory; and
at least one processor coupled with the at least one memory and configured to cause the base station to:
transmit a downlink semi-persistent scheduling (SPS) configuration, wherein the downlink SPS configuration includes a set of timer configurations;
transmit a physical downlink shared channel (PDSCH) on an SPS transmission occasion of the downlink SPS configuration.

12. A method performed by a user equipment (UE), the method comprising:
receiving a downlink semi-persistent scheduling (SPS) configuration, wherein the downlink SPS configuration includes a set of timer configurations;
receiving a physical downlink shared channel (PDSCH) on an SPS transmission occasion of the downlink SPS configuration; and
starting, based at least in part on receipt of the PDSCH on the SPS transmission occasion, a first timer that is set according to a corresponding timer value of the set of timer configurations.

13-20. (canceled)

21. The method of claim 12, wherein the set of timer configurations includes a discontinuous reception (DRX) retransmission timer and a DRX hybrid automatic repeat request (HARQ) round trip time (RTT) timer.

22. The method of claim 12, wherein starting the first timer comprises starting a DRX hybrid automatic repeat request (HARQ) timer configured in the SPS configuration in a first symbol after an end of a corresponding transmission carrying downlink HARQ feedback for the PDSCH.

23. The base station of claim 11, wherein the set of timer configurations includes a discontinuous reception (DRX) retransmission timer and a DRX hybrid automatic repeat request (HARQ) round trip time (RTT) timer.

24. The base station of claim 11, wherein the set of timer configurations includes a discontinuous reception (DRX) inactivity timer.

25. The base station of claim 11, wherein the set of timer configurations includes a discontinuous reception (DRX) On duration timer.

26. The base station of claim 11, wherein multiple SPS transmission occasions are included in an SPS period, and wherein, for each SPS occasion within the SPS period, a hybrid automatic repeat request (HARQ) process identifier is assigned to the SPS occasion based at least in part on a number of SPS transmission occasions included in the SPS period and a current SPS transmission occasion.

27. A method performed by a base station, the method comprising:
transmitting a downlink semi-persistent scheduling (SPS) configuration, wherein the downlink SPS configuration includes a set of timer configurations; and
transmitting a physical downlink shared channel (PDSCH) on an SPS transmission occasion of the downlink SPS configuration.

28. The method of claim 27, wherein the set of timer configurations includes a discontinuous reception (DRX) retransmission timer and a DRX hybrid automatic repeat request (HARQ) round trip time (RTT) timer.
